(19) United States
(12) Patent Application Publication
(10) Pub. No.: US 2005/0032554 A1
(43) Pub. Date: Feb. 10, 2005

(54) [ILLUMINATED CELLULAR PHONE CAR CHARGER AND ILLUMINATING APPARATUS]

(76) Inventor: BILL YANG, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,881

(22) Filed: Aug. 25, 2003

(30) Foreign Application Priority Data
Aug. 7, 2003 (TW) 92214321

(51) Int. Cl. H04B 1/00

(52) U.S. Cl. 455/573; 455/343.3

(57) ABSTRACT

A cellular phone car charger with an illuminating function comprising a power connection plug, a conductive cable, a charge connector and an illuminating device is provided. The power connection plug is connected to a power socket within a car for providing a charging power source. The conductive cable transmits the charging power source to the charge connector. The charge connector converts the charge power source into a form suitable for charging up a cellular phone. The illuminating device is set on the charge connector capable of using the charging power to illuminate surrounding areas. The illuminating device can also use the power source within the cellular phone to illuminate surrounding areas when the power connection plug is in an idle state and the charge connector is engaged to the cellular phone. The on or off state of the illuminating device can be controlled by a switch.

### CROSS REFERENCE TO RELATED APPLICATIONS

This application claims the priority benefit of Taiwan application serial no.92214321, filed on Aug. 7, 2003.

### BACKGROUND OF INVENTION

1. Field of the Invention

The present invention relates to a cellular phone car charger. More particularly, the present invention relates to an illuminated cellular phone car charger.

2. Description of the Related Art

Automobile is an indispensable vehicle for traveling to and from work or going on a vacation for many of us. For frequent travelers, a large portion of their time is spent driving a car. Another trend for traveling people is their frequent communication activities through a wireless communication system. In recent years, with the miniaturization of wireless communication devices, a cellular phone is carried around in pockets or handbags almost everywhere.

In general, a wireless communication consumes a lot of power. The power is normally supplied to a cellular phone by an attached rechargeable battery. However, because a cellular phone needs to be light and compact, storage capacity and size of the battery is severely restricted. Hence, the battery of a cellular phone has to be charged frequently for a frequent user. Due to the frequent traveling of cellular phone users, a cellular phone car charger has been developed to facilitate the recharging of phone battery.

FIG. 1 is schematic sketch showing the interior layout of a conventional when viewed from the side. As shown in FIG. 1, the interior space 100 of the car is bounded by a top section 102 and a bottom section. A driver seat is fastened to the bottom section and a driving wheel 108 is positioned in front of the driver seat. Almost every car has a power socket 110 for providing a local power source. In addition, a set of fixed illuminating lights 104 are normally installed on the lower surface of the top section 102. Because the illuminating lights 104 are fixed in position and only a limited number of them are installed, light intensity at some dead corner positions such as the one whose location is labeled 106 is low.

In general, a conventional cellular phone is provided with a car charger for recharging the phone battery through the power socket 110 (a 12V power source for most cars) of a car. FIG. 2 is a sketch showing a conventional cellular phone car charger when viewed from one side. As shown in FIG. 2, a conventional car cellular phone charger comprises a power connection plug 200, a conductive cable 202 and a charge connector 204. The power connection plug 200 can be inserted into the power socket 110. The power connection plug 200 normally incorporates a power conversion function for transforming the power voltage provided by the car to a suitable operating voltage for charging the phone battery. The operating voltage is connected to the charge connector 204 via the conductive cable 202. The charge connector 204 has a fixed configuration for engaging with the cellular phone 206 designed according to the model number of a particular product. The charge connector 204 provides the power necessary for recharging the phone battery.

Although most cars are equipped with a power socket for recharging a mobile phone, the illumination level at some corner areas within the car is often low. Since driving at night or along a dimly lit road is quite common for frequent travelers, the overhead lights 104 can hardly provide the illumination necessary for seeing things in corner areas. Furthermore, the overhead lights 104 may not provide sufficient illumination for reading text or pictures too. Moreover, with all the overhead lights 104 installed at fixed locations, searching for a dropped item or objects placed somewhere within the car is highly inconvenient.

In other words, a source of illumination is often required within the car in broad daylight and in particular, at night. Since the conventional overhead lights with fixed locations cannot provide sufficient illumination, an easy-to-install complementary source of illumination within the car is always desirable.

### SUMMARY OF INVENTION

Accordingly, one object of the present invention is to provide a cellular phone car charger with illuminating function whose charging end has an illuminating device. Utilizing a flexibility conductive cable that links up the charging end of the charger with a power socket within the car, the illuminating device can be brought into close proximity to almost every corner area within the car.

A second object of this invention is to provide a cellular phone car charger with illuminating function whose charging end has an illuminating device. A power source within the cellular phone can be utilized to power up the illuminating device when the charging section of the cellular phone car charger is plugged into the cellular phone.

To achieve these and other advantages and in accordance with the purpose of the invention, as embodied and broadly described herein, the invention provides a cellular phone car charger with illuminating function. The cellular phone car charger comprises a power connection plug, a charge connector and an illuminating device. The power connection plug is connected to a power socket within a car for receiving the power for charging up a phone battery. The charge connector is connected to the power connection plug via a conductive cable. In addition, the charge connector also converts the power from the power connection plug into a suitable form for charging a cellular phone. The illuminating device is set somewhere on the charge connector. The illuminating device uses some of the power from the power source to provide the illumination

The aforementioned illuminating device can also be illuminated using the power provided by a battery within the cellular phone when the power connection plug is in an idle state and the charge connector is engaged to the cellular phone.

This invention also provides a cellular phone illuminating apparatus. The illuminating apparatus comprises a connector and an illuminating device. The connector plugs into a cellular phone so that a battery source within the cellular phone can be tapped. The illuminating device is set on the connector for providing illumination using the battery power.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is schematic sketch showing the interior layout when viewed from the side of a conventional car.

FIG. 2 is a sketch showing a conventional cellular phone car charger when viewed from one side.

FIG. 3 is a side view of a cellular phone car charger according to one preferred embodiment of this invention.

FIG. 4 is a side view showing the operating mechanism of a cellular phone car charger according to this invention.

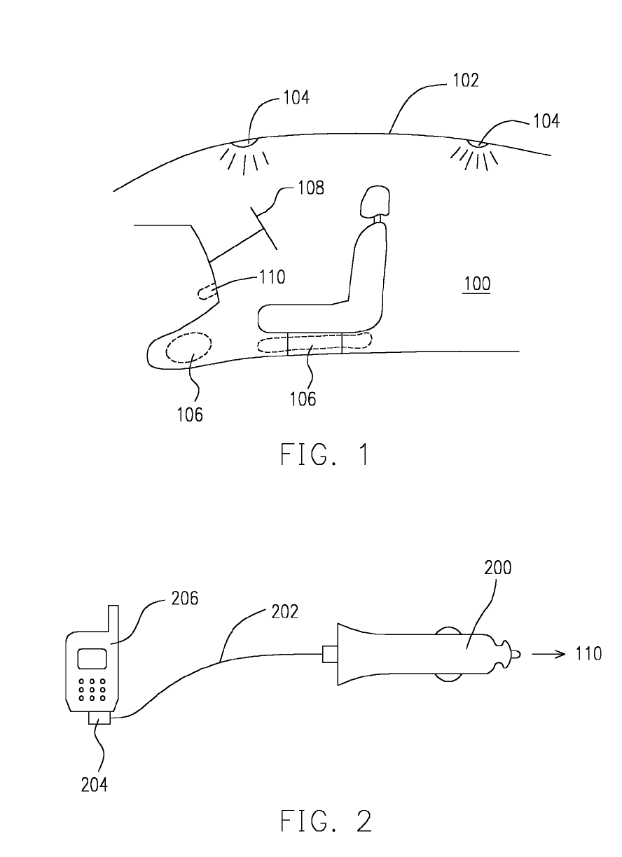

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

Cellular phones is now an indispensable tool of wireless communication equipment. Most cellular phones are provided with a car charger that can combine with a hands free phone set. Since the design of a conventional car interior is bound to have some dead illumination corners 106 as shown in FIG. 1, the cellular phone car charger may serve as a complementary illumination means within a car.

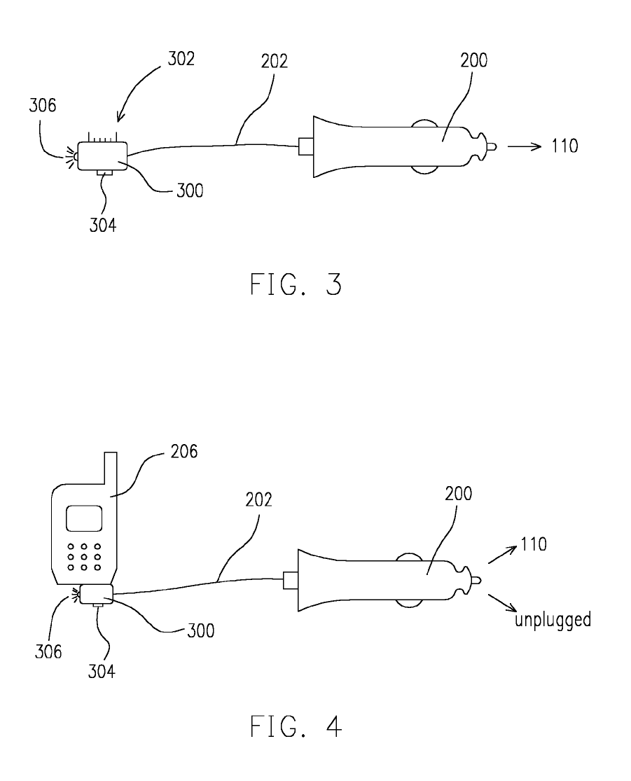

FIG. 3 is a side view of a cellular phone car charger according to one preferred embodiment of this invention. As shown in FIG. 3, the cellular phone car charger has a power connection plug 200 that can be plugged into a power socket 110 within the car. The power socket 110 of the car normally provides a voltage source of 12V, for example. To provide a power source suitable for the cellular phone, the power connection plug 200 may incorporate a circuit for performing a voltage transformation for a particular phone model. In other words, the power connection plug 200 may produce a voltage suitable for charging a selected cellular phone model.

The other end of the cellular phone car charger is a charge connector 300 connected to the power connection plug 200 via a conductive cable 200. Power from the power connection plug 200 is transmitted to the charge connector 300 through the cable 200. Furthermore, the charge connector 300 will distribute a portion of the electric power to a connection head 302 fabricated according to the specific model and brand of cellular phone. In general, the connection head 320 normally has a specific number of leads or a particular body shape.

This invention also provides an illuminating device 306 set on the charge connector 300. The illuminating device 306 can be turned on or off via a switch 304, for example.

When the power connection plug 200 is inserted into the power socket 110 of the car, the illuminating device 306 may light up by tapping a portion of the electric power provided for charging the cellular phone. Since the illuminating device 306 can directly or indirectly tap into the power provided by the power socket 110, there is no need for the charge connector 300 to plug into a cellular phone. However, the charge connector 300 may plug into a cellular phone to charge the phone battery at the same time.

FIG. 4 is a side view showing the operating mechanism of a cellular phone car charger according to this invention. As shown in FIG. 4, the illuminating device 306 can be separately controlled through the switch 304 when the cellular phone car charger is charging a cellular phone 206. The activation of the illuminating device 306 and the charging of the cellular phone 206 can be independently carried out when the power connection plug 200 is inserted into the power socket 110. In other words, the illumination of the illuminating device 306 is unaffected by the battery charging operation of the cellular phone 206.

However, if the power connection plug 200 is unplugged from the power socket 110 and hence remains in an idle state, connection between the charge connector 300 and the cellular phone 206 can still be maintained. Thus, the illuminating device 306 can be powered up by drawing a current from the battery of the cellular phone 206.

In this invention, the conductive cable 202 is extensible so that the illuminating device 306 can be moved to almost any corners within the car when the power source of the car is used. However, even if the power source to the cellular phone charger is unplugged, the power source within the cellular phone 206 can still provide power to the illuminating device 306 on the charge connector 300. In fact, the power connection plug 200 and the conductive cable 202 can be removed without interrupting the illumination.

In addition, the charge connector 300 specification may be simplified as long as the power source of the cellular phone 206 can be used. The illuminating device 306 can be switched on or off according to whether the cellular phone 206 is plugged into or unplugged from the charge connector 300. Alternatively, a switch 304 is set to select on or off state of the illuminating device 306.

The circuit for operating the system according to this invention can be modified according to the design. Since conventional circuit design may be deployed, detailed description of such circuits is omitted herein.

Major aspects of this invention at least includes: 1. By utilizing the flexibility of a cable linking the charging terminal and the power socket terminal, the illuminating device can be moved to illuminate every dead corners within the car. 2. With the illuminating device set on the charging terminal of the car charger, either the power source within a cellular phone or the power source provided by the car can be used to power the illuminating device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A cellular phone car charger with illuminating function, comprising:
a power connection plug, for connecting with a power socket that provides a charging source;
a conductive cable;
a charge connector for receiving charging power via the conductive cable and converting the power to a suitable form for charging the cellular phone; and
an illuminating device set on the charge connector for illuminating surrounding areas using power from the charging source.

2. The car charger of claim 1, wherein the illuminating device uses the power of a battery within the cellular phone to illuminate surrounding areas when the power connection plug is in an idle state and the charge connector is engaged to the cellular phone.

3. The car charger of claim 1, wherein the charger further comprises a switch set on the charge connector for controlling on or off state of the illuminating device.

4. The car charger of claim 1, wherein the power socket in the car provides a 12V power source.

5. The car charger of claim 1, wherein the power connection plug produces a power source having a correct charging voltage via a voltage transformer.

6. The car charger of claim 1, wherein the conductive cable permits the charge connector to move and illuminate most dead corner areas within the car.

7. The car charger of claim 6, wherein the dead corner areas within the car are the areas within the car where insufficient illumination is provided by at least one fixed overhead lamp.

8. A cellular phone illuminating apparatus with an illuminating function, comprising:
a connector for plugging into a cellular phone and connecting to a battery source; and
an illuminating device set on the connector for illuminating surrounding areas using the battery power.

9. The cellular phone illuminating apparatus of claim 8, wherein the apparatus further comprises a switch for controlling on or off state of the illuminating device.
